(19) United States
(12) Patent Application Publication
(10) Pub. No.: US 2009/0038719 A1
(43) Pub. Date: Feb. 12, 2009

(54) METHOD OF MANUFACTURING A THERMO-ELECTRIC MATERIAL CONSISTING OF A THERMO-ELECTRIC SUBSTRATE WITH THERMAL SCATTERING CENTERS AND THERMO-ELECTRIC MATERIAL

(76) Inventors: Harald Boettner, Freiburg (DE); Joachim Nurnus, Neuenberg (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/917,693

(22) PCT Filed: Jun. 14, 2006
(86) PCT No.: PCT/EP2006/005739

§ 371 Date: Jul. 8, 2008

(30) Foreign Application Priority Data
Jun. 15, 2005 (DE) 10 2005 027 680.6

(51) Int. Cl. C22F 1/00; B32B 5/00

(52) U.S. Cl. 148/538; 148/405

(57) ABSTRACT

The present invention refers to a method of manufacturing a thermo-electric material consisting of a thermoelectric substrate with thermal scattering centers, in which a melt at least of the substrate is cooled in a manner that the scattering centers are generated as nano-scale precipitations from the melt embedded in the substrate and a material manufactured accordingly.

### TECHNICAL FIELD OF THE INVENTION

The present invention refers to a method of manufacturing a thermo-electric material consisting of a thermo-electric substrate with thermal scattering centers and thermo-electric material.

The thermo-electric effectiveness ZT of thermo-electric materials can be increased by introducing thermal scattering centers into a substrate (or a carrier matrix), if the thermal scattering centers influence the electrical properties of the substrate marginally only. A precondition for a high efficiency of the thermo-electric material is the use of substrates with favorable thermo-electric effectiveness in the desired temperature range for usage. The thermal scattering centers enclosed in the substrate shall furthermore not adversely affect the thermal properties of the substrate.

These and similar considerations were so far analyzed experimentally only in the field of nano-scale thin-layer systems on the basis of thermo-electric standard materials. Here, the scattering centers have two-dimensional (interfaces in overlay grids or multi-quantum well systems), one-dimensional (wires) or zero-dimensional (spots) character.

The disadvantage of these nano-scale thin-layer systems is particularly that materials that can be used industrially and therefore in production do not exist.

The use of special deposition methods in the field of nano-scale thin-layer systems also limits their use for industrially usable components. The growth rate for conventional PVD deposition methods for nano-scale thermo-electric materials, such as MOCVD or MBE lies in the scale of 0.07 μm per hour. Compared to a height of a leg in industrial thermoelectric components of at least 500 μm an obvious weakness of the known methods becomes evident.

Thus it is the object of the present invention to provide a method of manufacturing a thermoelectric material consisting of a thermo-electric substrate with thermal scattering centers in a bulk format for the industrial manufacture of components.

The present object is solved according to the invention by a method of manufacturing a thermo-electric material consisting of a thermo-electric substrate (carrier matrix) with thermal scattering centers, wherein a melt at least of the substrate (of the carrier matrix) is cooled such that the scattering centers are produced as nano-scale precipitation from the melt embedded in the substrate (in the carrier matrix).

The method according to the invention enables in an advantageous manner the introduction of nano-scale scattering centers (“guest”) into thermoelectric highly efficient substrates (“host”) by the use of suitable melts and cooling methods. This “nano-guest-host” (NHG) principle through melts enables a variety of embodiments with simple and scalable process conduct for the manufacture of materials in the industrial environment and a maximization of the thermo-electric effectiveness of the substrate and of the thermal scattering centers. The way over the melts particularly takes the “scale-up” into account that is industrially required.

The cooling process is preferably followed by a tempering process. The substrate can be adjustable by tempering as an n-conductive phase or p-conductive phase.

According to a preferred embodiment, the substrate and the nano-scale scattering centers have thermoelectric properties. This results in an especially advantageous embodiment of the present NHG principle in which both the “host” material as well as the “guest” material can thermo-electrically be highly effective.

According to a further embodiment, a binary IV-VI compound, particularly PbTe, PbS, SnSe or SnTe is used as a melt, wherein this binary IV-VI compound forms the substrate and at least one of the components of the binary IV-VI compound forms the nano-scale scattering centers. For PbTe as melt, Pb precipitations or Te precipitations or as Pb-rich or Te-rich precipitations as nano-scale scattering centers in a PbTe matrix as substrate can be formed by quenching followed by a tempering process.

According to a further embodiment, a binary V-VI compound, particularly Bi₂Te₃, Bi₂Se₃, Sb₂Se₃ or Sb₂Te₃ is used as a melt, wherein the binary V-VI compound forms the substrate, and at least one of the components and/or sub-combination of the components of the binary V-VI compound forms the nano-scale scattering centers. BiTe precipitations or Te precipitations as nano-scale scattering centers in a B₂Te₃ matrix as substrate can be formed by quenching followed by a subsequent tempering process e.g. for Bi₂Te₃ as a melt.

According to a further embodiment, a quasi-binary IV-VI compound, particularly (PbSn)Te, (PbSn)Se or (PbSn)S is used as a melt. The optimal thermo-electric usage temperature of the substrate can be set via a portion of Sn in the melt. Furthermore, a band gap of the substrate can be decreased by the addition of SnTe and/or elementary Sn, whereby the optimal thermo-electric usage temperature is reduced.

According to a further preferred embodiment, a two-component system composed of Bi₂Te₃ and PbTe is used as melt, wherein according to the temperature control during cooling PbBi₄Ti₇ precipitation as nano-scale scattering centers in Bi₂Te₃ as substrate or in PBTe as substrate are set.

According to a further embodiment, a quasi-binary alloy of Pb or S or Se or Te with particularly Ba, Ca, Sr, Eu or Ge as cationic mixed crystal partner is used. The band gap of the substrate can be enlarged by the cationic mixed crystal partners, wherein the optimum usage temperature of such thermo-electric material composites is shifted towards higher temperatures.

It is a further object of the present invention to provide a nano-scale thermo-electric material in bulk format for the industrial manufacture of components.

This object according to the invention is solved by a thermoelectric material with thermal scattering centers embedded as nano-scale precipitations from a melt in a thermo-electric substrate (a carrier matrix). The nano-scale precipitations preferably consist of a thermo-electric material.

The present invention will now be described by means of preferred embodiments in connection with the associated drawings.

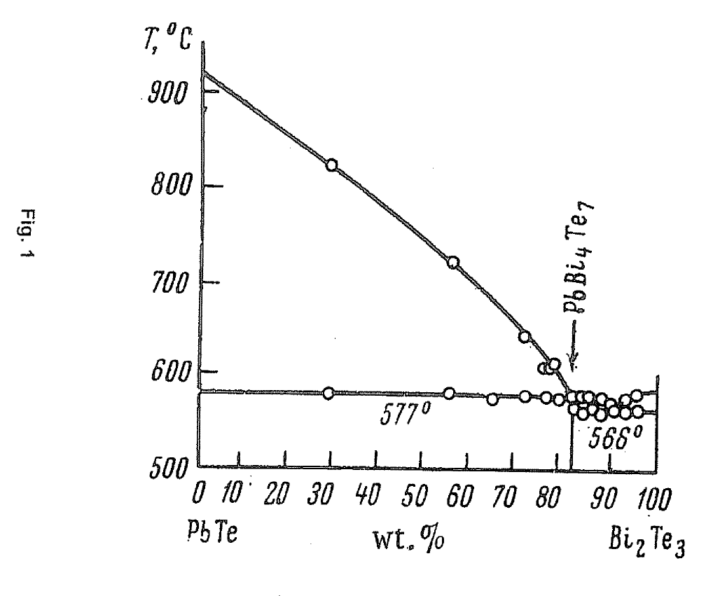

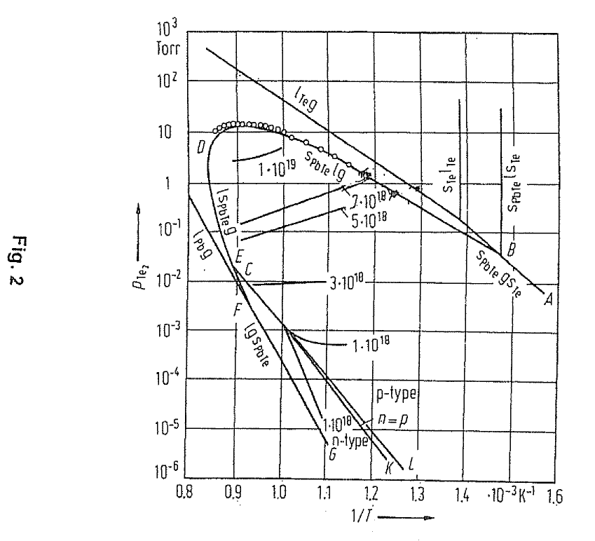

FIG. 1 shows a phase diagram of a two-component system PbTe-Bi₂Te₃;

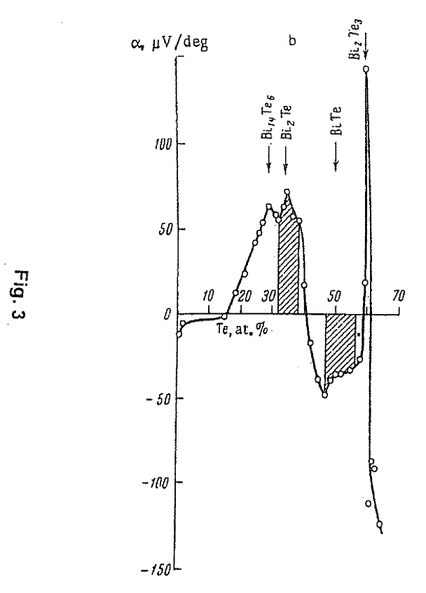

FIG. 2 shows a view of the generation of n- or p-conductive phases for the two-component system PbTe according to FIG. 1;

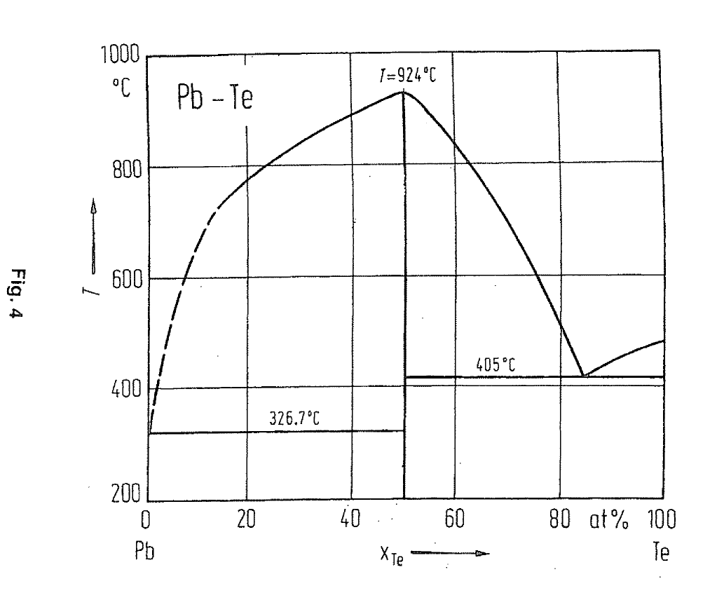

FIG. 3 shows a view of the Seebeck coefficient for illustrating the thermo-electric properties of Bi₂Te₃, wherein the generation of n- and p-conductive phases can be seen;

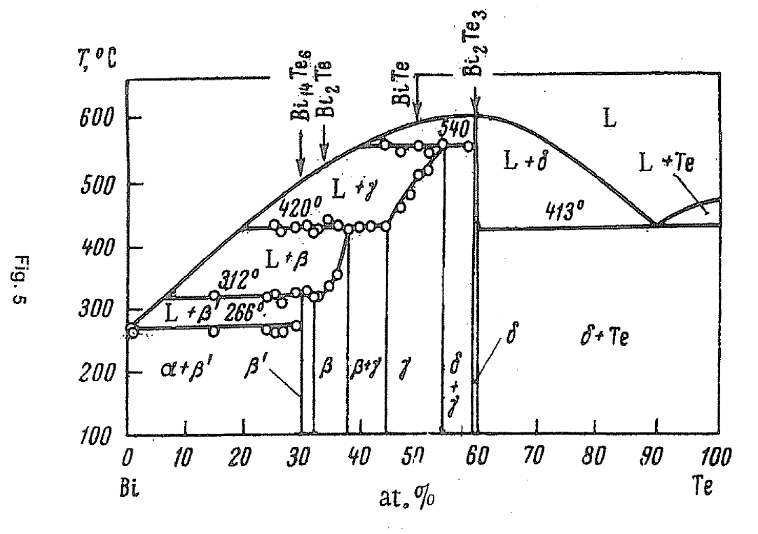

FIG. 4 shows a phase diagram of the system Pb—Te;

FIG. 5 shows a phase diagram of the system Bi—Te;

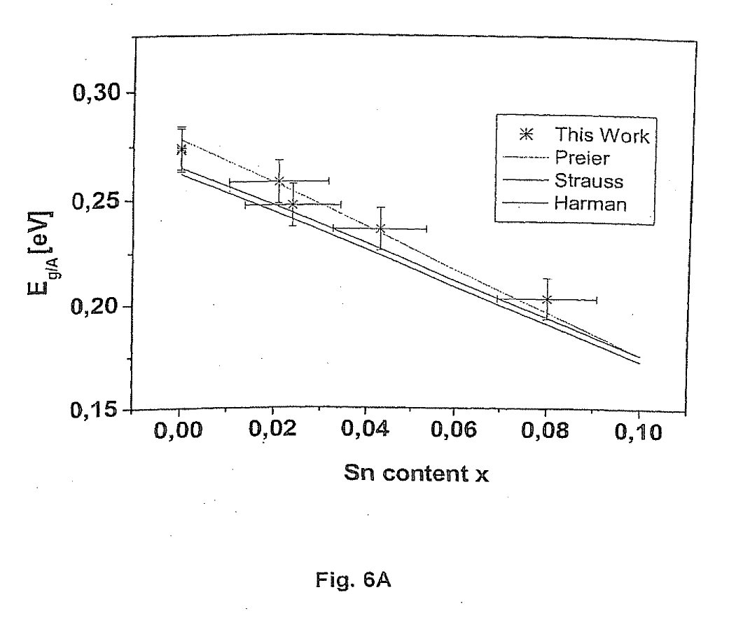

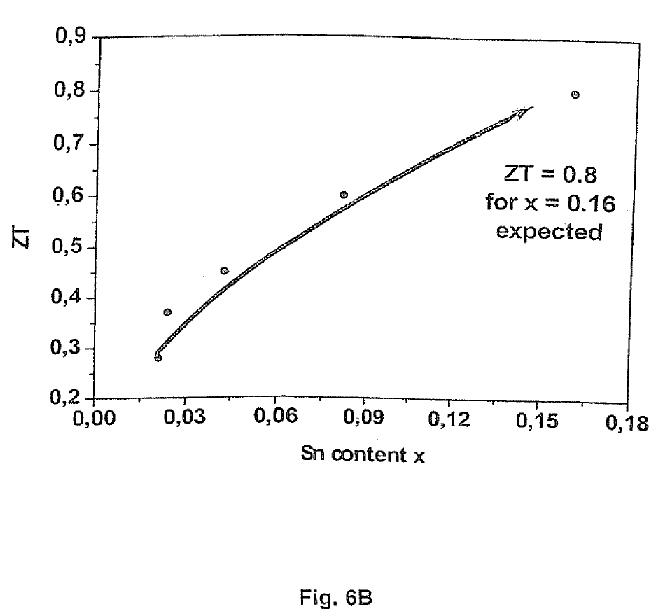

FIG. 6 A shows measured infra-optical absorption edges in the system (PbSn)Se; and

FIG. 6 B shows thermoelectric effectiveness ZT at 300 Kelvin in the system (PbSn)Se.

Embodiments of thermo-electric massive materials and methods of producing same will now be explained.

FIG. 1 shows the two-component system Bi₂Te₃-PbTe as a preferred material system for a “nano-guest-host” (NHG) approach with thermo-electric materials only.

It can be understood from the phase diagram shown in FIG. 1 that by suitable melts, quenching processes and subsequent tempering both PbBi₄Te₇ precipitations in Bi₂Te₃ as well as PbBi₄Ti₇ precipitations in PbTe can be set.

This is particularly advantageous, since on the one hand nano-scale scattering centers in the thermoelectric room temperature material Bi₂Te₃ as well as scattering centers in the thermo-electric mean temperature material PbTe can be produced.

The precipitation material PbTi₄Te₇ being an independent phase also represents a favorable thermo-electric material.

Above that both the Bi₂Te₃-“host” phase as well as the PbTe-“host” phase can be set both as p- and as n-type material by a respective tempering process, as may be derived from FIGS. 2 and 3. FIG. 2 shows the logarithm log p above the coefficient 1/T for PbTe and FIG. 3 shows the Seebeck coefficient for the thermo-electric properties of Bi₂Te₃.

This embodiment shows an option of producing the thermo-electric base materials that seem to be the two most important base materials at tile moment:
Bi₂Te₃ in the room temperature range and
PbTe in the range around 300° C.
as n- and p-conductive material by using the advantageous nano-scale precipitations to form the scattering centers.

A further material system for the NHG approach is the Pb—Te system shown in FIG. 4. According to FIG. 4 a PbTe matrix can be produced as substrate by a suitable composition of the melts, by quenching followed by a tempering process, in which Pb precipitations and Te precipitations are embedded.

Besides the Pb—Te system shown in FIG. 4, the above-mentioned description applies analogously to other binary IV-VI compounds, particularly for PbSe, PbS, SnSe or SnTe.

According to a further material system for the NGH approach, the Bi—Te system is shown in FIG. 5. According to FIG. 5 it can therefore be taken care that by a suitable composition of the melts and by quenching with a subsequent tempering process BiTe precipitations or Te precipitations exist in a Bi₂Te₃ matrix.

The Bi—Te system is exemplary for binary V-VI compounds, particularly Bi₂Se₃, Sb₂Se₃ and Sb₂Te₃, wherein the above-mentioned statements apply analogously to the respective phase diagrams.

A further material system for the NGH principle is formed by quasi-binary IV-VI compounds, such as (PbSn)Te, (PbSn)Se and (PbSn)S. In this embodiment it must be emphasized that the usage temperature of the “host” material (i.e. of the substrate) can be varied via the Sn-content, as shown in FIG. 6 for (PbSn)Se. Furthermore, the band gap of the substrate can be reduced by the addition of SnTe or of elementary Sn, whereby the optimal usage temperature on the basis of e.g. 600 Kelvin in PbTe can be shifted to temperatures around 300 Kelvin and lower.

The above statements apply analogously to quasi-binary alloys of Pb with —S, —Se or —Te with e.g. the cationic mixed crystal partners Ba, Ca, Sr, Eu or Ge. In these compounds the band gap is enlarged by the last mentioned elements, i.e. the optimal usage temperature is shifted towards higher temperatures.

1. Method of manufacturing a thermoelectric material composed of a thermoelectric substrate with thermal scattering centers, wherein a melt at least of the substrate is cooled such that the scattering centers are produced as nano-scale precipitations from the melt embedded in the substrate.

2. Method as claimed in claim 1, characterized by a tempering process following the cooling process.

3. Method as claimed in claim 2, characterized in that the substrate can be set by tempering as n-conductive phase or as p-conductive phase.

4. Method as claimed in claim 1, characterized in that the substrate and the nano-scale scattering centers have thermo-electric properties.

5. Method as claimed in claim 1, characterized in that a binary IV-VI compound, particularly PbTe, PbS, SnSe or SnTe is used as melt, wherein the binary IV-VI compound forms the substrate, and at least one of the components of the binary IV-VI compound forms the nano-scale scattering centers.

6. Method as claimed in claim 5, characterized in that Pb- or Te-precipitations and/or Pb- or Te-rich precipitations as nano-scale scattering centers in a PbTe matrix are formed as substrate for PbTe as melt by quenching followed by a tempering process.

7. Method as claimed in claim 1, characterized in that a binary V-VI compound, particularly Bi₂Te₃, Bi₂Se₃, Sb₂Se₃ or Sb₂Te₃ is used as melt, wherein the binary compound V-VI forms the substrate and at least one of the components and/or sub-combinations of the components of the binary V-VI compound forms the nano-scale scattering centers.

8. Method as claimed in claim 7, characterized in that BiTe precipitations or Te precipitations as nano-scale scattering centers in a Bi₂Te₃ matrix are formed as a substrate for Bi₂Te₃ as melt by quenching followed by a tempering process.

9. Method as claimed in claim 1, characterized in that a quasi-binary IV-VI compound, particularly (PbSn)Te, (PbSn)Se or (PbSn)S is used as melt.

10. Method as claimed in claim 9, characterized in that an optimal thermo-electric usage temperature of the substrate is set via a portion of Sn in the melt.

11. Method as claimed in claim 9, characterized in that the band gap of the substrate is reduced by the addition of SnSe, SnS or SnTe and/or elementary Sn, whereby the optimal thermo-electric usage temperature is reduced.

12. Method as claimed in claim 1, characterized in that a two-component system composed of Bi₂Te₃ and PbTe is used as melt, wherein according to the temperature control during the cooling process PbBi₄Te₇ precipitations are set as nano-scale scattering centers in Bi₂Te₃ as substrate or in PbTe as substrate.

13. Method as claimed in claim 1, characterized in that a quasi-binary alloy of Pb or S or Se or Te is used as melt with particularly Ba, Ca, Sr, Eu or Ge as cationic mixed crystal partner.

14. Method as claimed in claim 13, characterized in that the band gap of the substrate is enlarged by the cationic mixed crystal partner, wherein the optimal usage temperature of such thermoelectric material composites is shifted towards higher temperatures.

15. Thermo-electric material with thermal scattering centers embedded as nano-scale precipitations from a melt in a thermoelectric substrate.

16. Thermo-electric material as claimed in claim 15, characterized in that the nano-scale precipitations are composed of a thermoelectric material.
